(19) United States
(12) Patent Application Publication
(10) Pub. No.: US 2024/0301824 A1
(43) Pub. Date: Sep. 12, 2024

(54) SYSTEM FOR GENERATING CAVITATION INCLUDING CANTILEVERED BEARING CONFIGURATION

(71) Applicant: Micro-Combustion LLC, Chicago, IL (US)

(72) Inventors: Davis Anderson, Chicago, IL (US); Tyler Erickson, Chicago, IL (US)

(21) Appl. No.: 18/667,587

(22) Filed: May 17, 2024

Related U.S. Application Data
(63) Continuation-in-part of application No. 17/902,149, filed on Sep. 2, 2022.
(60) Provisional application No. 63/503,313, filed on May 19, 2023.

(51) Int. Cl. F02C 6/18; F01D 15/10

(52) U.S. Cl. CPC F02C 6/18; F01D 15/10

(57) ABSTRACT

The invention relates generally to waste exhaust energy recovery and, in particular, a system or a retrofit kit for generating cavitation including a cantilevered bearing arrangement. The system may include a turbine wheel configured to drive an input shaft in response to exhaust energy. The input shaft may further support a cavitation impeller for generating pressure, fluid flow, and cavitation within a fluid. Upon collapsing, the cavitation bubbles may release energy that is captured by an output turbine mounted on an output shaft. Output shaft may harness the captured energy, which may be transmitted to an output device to, for example, turn a crankshaft to add torque or operate a generator to charge an external power source, such as a battery. Additionally, the system facilitates reducing emissions and fuel consumption while also supporting enhanced performance.

### RELATED APPLICATIONS

This application is a nonprovisional application which claims priority to U.S. application Ser. No. 17/902,149, filed Sep. 2, 2022, and U.S. Provisional Application No. 63/503,313, filed May 19, 2023, each of which is incorporated by reference herein in its entirety.

### FIELD OF THE INVENTION

The invention relates generally to a system and retrofit kit including a cavitation impeller and turbine, for uses that may include waste exhaust energy recovery, and more particularly, a system and retrofit kit for generating cavitation including a cantilevered bearing configuration.

### BACKGROUND

Internal combustion engines are often used to power, for example, vehicles, ships, airplanes, trains, generators, and other types of machinery. Examples of internal combustion engines include gasoline engines, diesel engines, gas turbines, jet engines, and rocket engines.

Typically, internal combustion engines generate exhaust gas pressure and heat as a result of inefficiencies associated with converting fuel into energy. As pressure and heat represents energy potential, it is often desirable to recover energy from the exhaust gasses for conversion into mechanical and/or electrical power. This recovery may improve performance, enhance the fuel efficiency of the vehicle, and reduce harmful emissions.

Conventional systems are often configured to recover heat from a high temperature source, such as an exhaust. Such traditional systems may include components that extract the heat from, for example, the exhaust gas produced by an internal combustion engine, particularly if sufficient pressure (above atmospheric) is present in the exhaust gas. Example components of traditional waste heat recovery systems may include exhaust gas recirculation (EGR) boilers, pre-charge air coolers (pre-CAC), exhaust system heat exchangers or other components configured to extract heat.

However, conventional systems are susceptible to failures. For example, traditional systems often develop mechanical malfunctions and/or leakages due to, for example, corrosion or fatigue. Such malfunctions are often difficult and costly to repair. Also, conventional systems are often inefficient. Inefficiencies of traditional systems may be caused by heat loss, frictional loss, and unharnessed work.

Therefore, there is a need for a system that is more efficient, smoother running, and less susceptible to malfunctions, in uses such as waste exhaust energy recovery. The present invention satisfies this need.

### SUMMARY

The invention relates generally to a system for waste exhaust energy recovery. More specifically, the system of the present disclosure relates to a system for generating cavitation including a cantilevered bearing configuration to facilitate facilitates reducing emissions and fuel consumption while also supporting enhanced performance.

In one aspect, the system may include an exhaust turbine having a turbine wheel mounted on an input shaft. The exhaust turbine may couple with a vortex drive and cavitation generator configured to receive the input shaft. The generator may further include one or more inlets configured to receive a fluid.

The generator may include impellers and turbines for generating cavitation and harnessing cavitation combustion energy. Specifically, a cavitation impeller may be mounted on the input shaft and configured to induce cavitation within the fluid. The cavitation impeller may include a plurality of impeller blades extending from a surface of a frame of the impeller. The plurality of blades may be curved and/or proportionally spaced about the surface of the impeller frame. It is further contemplated that cavitation impeller may be double-sided such that impeller blades extend from a front surface and a rear surface of the frame.

The generator may further include an output shaft. Output shaft may extend from a flow chamber of the generator to a vortex chamber. The vortex chamber may be shaped to resemble a venturi cone including a mouth portion, a throat portion, and a discharge portion. The vortex chamber in this configuration may facilitate increasing the velocity of fluid flow through the generator.

Furthermore, an output turbine may be mounted on the output shaft. The output turbine may include a plurality of blade extending outwardly toward an interior surface of the vortex chamber. Each output turbine blade may be tapered to conform to the conical (i.e., venturi) shape of the vortex chamber. In response to cavitation implosion combustion, output turbine may be configured to rotate and drive the output shaft. It is further contemplated that the output shaft may be spaced a distance from the input shaft to optimize cavitation implosion combustion.

In an exemplary operation, the energy from the implosion of bubbles may be harnessed via the output turbine and transmitted to output shaft. The energy captured by output shaft may then be used to power an output device. For example, energy captured by output shaft may be used to energize a power source. As another example, the output device may include a plurality of gears or a cog belt and cog gears mechanically coupled a crankshaft or other device to increase torque, horsepower, efficiency, and the like.

Moreover, cantilever bearing assembly of the generator may improve the efficiency and overall output power. More specifically, the cantilever bearing may be configured to support the output shaft. It is further contemplated that the cantilever bearing assembly may facilitate reducing vibration with the generator. The cantilever bearing assembly may be positioned proximate to the output turbine on the output shaft and include one or more arms or spokes extending from a carrier. Each arm of the assembly may extend from the carrier to an interior surface of the generator housing or an interior surface of the vortex chamber.

The generator may further be configured to recirculate a fluid. In particular, housing of the generator may include a recirculation path in fluid communication with the generator inlet to facilitate internal recirculation. The recirculation path may be configured in an open position or a closed position for controlling the amount of fluid recirculated back through the inlet.

Another aspect of the present disclosure includes a retrofit kit for waste exhaust energy recover. The kit may include a generator having housing including a front end and a rear end. The front end of the housing may receive an input shaft. The input shaft is configured to receive a rotational input from a turbine wheel driven by exhaust energy.

The input shaft may further rotatably couple with a cavitation impeller. Cavitation impeller may be configured to generate cavitation with a fluid that is input into the housing via an inlet. The generator of the kit may further include an output turbine mounted on the output shaft. The output turbine may be configured to rotate in response to combustion of the cavitation and the fluid flow. As mentioned above, the input shaft may be space apart from an output shaft extending through the housing to optimize cavitation implosion combustion.

The output shaft may extend through a plurality of chambers of the housing. Chambers of the generator may include an expansion combustion chamber to facilitate cavitation micro-combustion. Further, a vortex chamber of the generator may facilitate increasing the velocity of fluid flow through the housing. In addition, fluids from vortex chamber may be received by a flow chamber of the housing, which may recirculate the fluid and/or allow the fluid to exit via the rear end of the generator.

Moreover, output shaft may exit the rear end through an opening of an end cap. Output shaft may further mechanically couple with an output device, such as current generator configured energize a power source, a gear assembly configured to generate a mechanical energy, or a cog belt and gears. Advantageously, the kit can harness the captured energy and facilitate reducing emissions and fuel consumption while also supporting enhanced performance.

While the invention is susceptible to various modifications and alternative forms, specific exemplary embodiments thereof have been shown by way of example in the drawings and have herein been described in detail. It should be understood, however, that there is no intent to limit the invention to the particular embodiments disclosed, but on the contrary, the intention is to cover all modifications, equivalents, and alternatives falling within the scope of the invention as defined by the appended claims.

### BRIEF DESCRIPTION OF THE DRAWINGS

Embodiments are illustrated by way of example and not limitation in the figures in the accompanying drawings, in which like references indicate similar elements and in which:

FIG. 1 illustrates an exemplary waste exhaust energy recovery system;

FIG. 2 illustrates a top perspective view of an exemplary exhaust turbine and exemplary generator of the exemplary system of FIG. 1;

FIG. 3 illustrates a bottom perspective view of the exhaust turbine and generator of FIG. 2;

FIG. 4 illustrates a rear cap of the generator of FIG. 2;

FIG. 5 illustrates a view of the generator of FIG. 2;

FIG. 6 illustrates a front cap of the generator of FIG. 2;

FIG. 7 illustrates a sectional view of the exhaust turbine and generator of FIG. 2;

FIG. 8 illustrate components of the exemplary generator of FIG. 2, including an input shaft, a cavitation impeller, an output shaft, and an output turbine.

FIG. 9A illustrates a perspective view of an exemplary cavitation impeller;

FIG. 9B illustrates a front view of the exemplary impeller of FIG. 9A;

FIG. 9C illustrates a side view of the exemplary impeller of FIG. 9A;

FIG. 10A illustrates a perspective view of an exemplary output turbine assembly;

FIG. 10B illustrates a rear view of the exemplary output turbine assembly of FIG. 10A;

FIG. 10C illustrates a front view of the exemplary output turbine assembly of FIG. 10A;

FIG. 10D illustrates a side view of the exemplary output turbine assembly of FIG. 10A;

FIG. 11A illustrates a perspective view of an exemplary jet turbine;

FIG. 11B illustrates a top view of the exemplary jet turbine of FIG. 11A; and

FIG. 12 illustrates a graph of mechanical efficiency vs. input power for waste exhaust energy recovery.

### DETAILED DESCRIPTION OF THE INVENTION

The invention relates generally waste exhaust energy recovery and, in particular, a system and for generating cavitation including a cantilevered bearing arrangement. As detailed below, one or more impellers of the system may be configured to generate pressure, flow, and cavitation bubbles, which, upon collapsing, release energy that may be captured by the output turbine. Advantageously, the system can harness the captured energy to, for example, turn a crankshaft to add torque or operate a generator to charge an external power source, such as a battery. Additionally, the system facilitates reducing emissions and fuel consumption while also supporting enhanced performance.

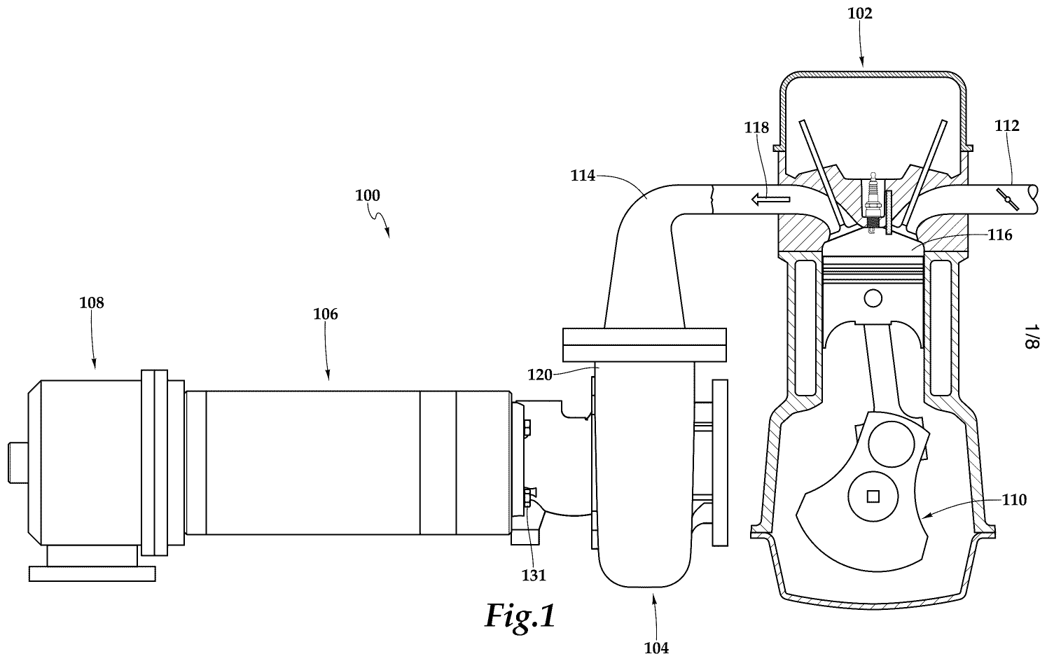

Turning now to the drawings wherein like numerals represent like components, FIG. 1 illustrates an exemplary waste exhaust energy recovery system 100 including an internal combustion engine 102, an exhaust turbine 104, a vortex drive and generator 106, and an output device 108, such as a gearbox or generator.

As shown, engine 102 may be an internal combustion engine that facilitates powering, for example, motor vehicles, watercrafts, amphibious vehicles, aircrafts, and spacecrafts. Preferably, engine 102 is a diesel (compression ignition) engine. Other engines are contemplated, such as a spark ignited gasoline engine, a spark ignited natural gas engine, or any other suitable engine, which combusts a mixture of fuel and air to produce power.

Generally, as shown in FIG. 1, engine 102 may include one or more engine cylinders 110. Each cylinder 110 may be associated with a combustion chamber 116. Further, cylinder 110 may be associated with one or more air intake valves 112 and one or more exhaust valves 114. Exhaust valves 114 may be used to discharge exhaust gases from cylinder 110. While engine 102 is running, exhaust gas is configured to flow along an exhaust path 118 of exhaust valve 114.

Exhaust turbine 104 may be in fluid communication with engine 102 and configured to capture the exhaust energy flowing via path 118 of exhaust valve 114. As shown in FIGS. 1-3, exhaust turbine 104 may include an inlet 120 configured to receive exhaust gases from the exhaust valve 114, and an outlet 122 through which exhaust gases may exit. It is further contemplated that exhaust gases may be directed to other components, including other rotary mechanical devices of system 100. For instance, system 100 may include a turbocharger or a turbo-compound device (not shown) configured to be driven by exhaust gas from engine 102.

As detailed below, the flow of exhaust gas through inlet 120 of exhaust turbine 104 facilitates rotating a drive turbine for system 100. The rotational input generated by the turbine of system 100 turns the power input shaft of system 100. As one or more shafts of system 100 are turned, power may be generated and transmitted to output device 108 of FIG. 1. While output device 108 is illustrated to be substantially flush with generator 106 in FIG. 1, other configurations are contemplated. For example, generator 106 and output device 108 may be separated by a defined distance. In another example, a shell of output device 108 may overlap a portion of generator 106.

Output device 108 may facilitate generating electricity or a mechanical force. For example, output device 108 may be a current generator configured to generate electrical current that may be used to, for example, power or recharge a power source (e.g., battery) of a vehicle. In another example, output device 108 may include a plurality of gears or a cog belt and cog gears mechanically coupled to, for example, a crankshaft (not shown) or other device to increase torque, horsepower, efficiency, and the like. It is further contemplated that output device 108 may be any other suitable type of device that converts mechanical energy into another form of energy.

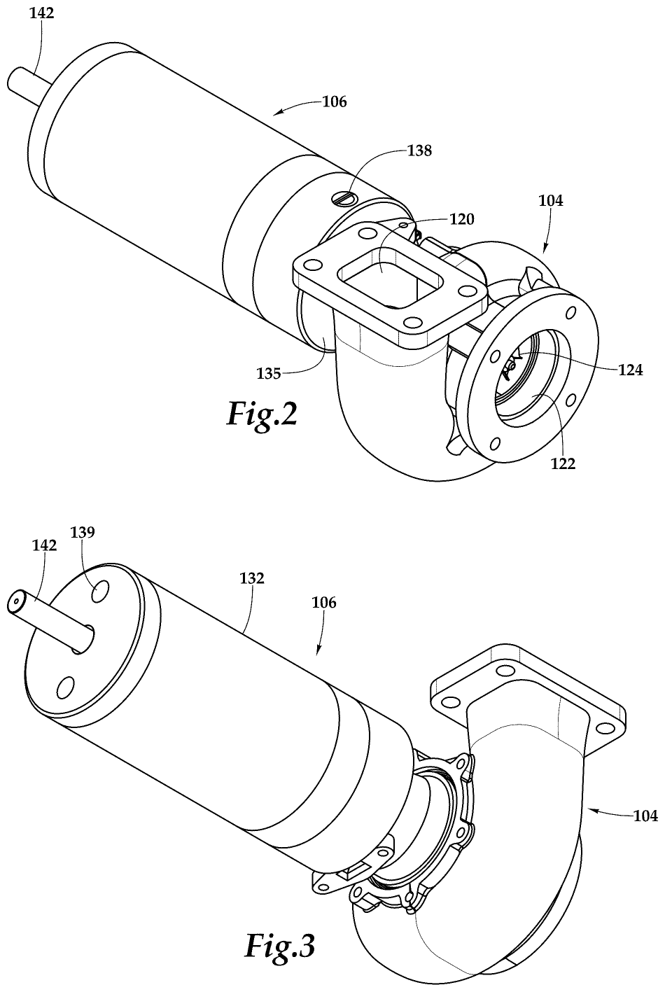

FIGS. 2-7 illustrate additional views of exhaust turbine 104 and generator 106. As shown, exhaust turbine 104 may be configured to receive exhaust gas from engine 102 via inlet 120, such as in a transverse direction relative to outlet 122. Further, exhaust turbine 104 may include an auxiliary turbine wheel 124. Turbine wheel 124 may be driven by exhaust gases directed through the inlet 120. Exhaust gases may then exit via outlet 122, such as in an axial direction.

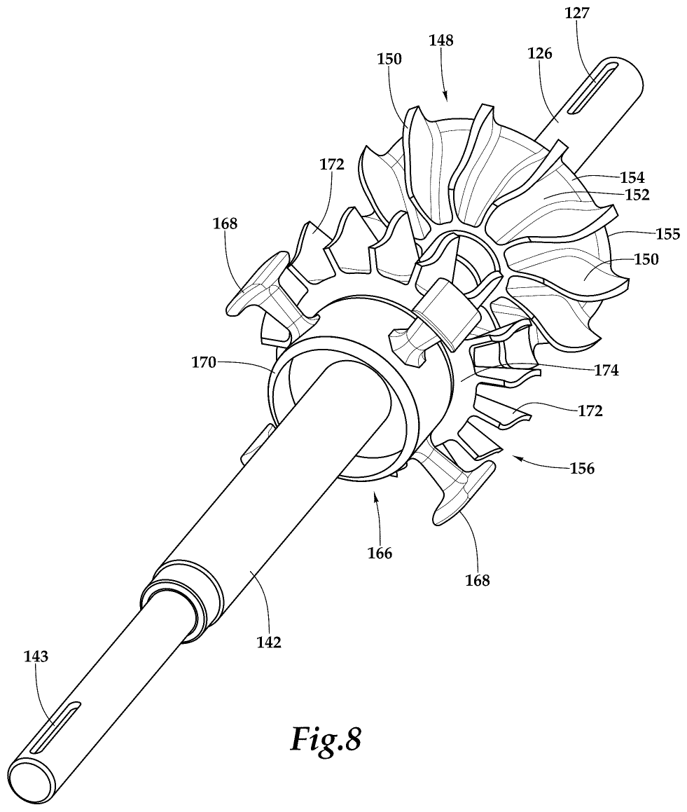

As illustrated in the sectional view of FIG. 7, turbine wheel 124 of exhaust turbine 104 may be mounted on an input shaft 126. For instance, input shaft 126 may include one or more slits 127 (FIG. 8) for receiving and securing turbine wheel 124 and/or other components of system 100. Other mechanical connections are contemplated.

As shown in FIG. 7, input shaft 126 may extend from outlet 122 into generator 106. Input shaft 126 may be further supported by one or more bearings, such as a cantilever bearing 128 of generator 148. As shown, cantilever bearing may be arranged proximate rear end 134 of housing 132. Moreover, generator 106 may mechanically couple with exhaust turbine 104 via one or more fasteners or clips (FIG. 1) and further include rotary seals and/or bushings 130 (FIG. 7) to, for example, prevent leakage of a fluid out of generator 106.

FIGS. 1-7 further illustrate an exemplary generator 106 of system 100. One or more portions of generator 106 may be constructed from metals and/or alloys, such as stainless steel, cobalt-chrome alloy, titanium, and nickel-titanium alloy.

A length of generator 106 may range between about ten inches and about eighteen inches, and preferably between about twelve inches and about fifteen inches. In certain embodiments, generator 106 may be about eight inches in length. Other lengths of generator 106 are contemplated.

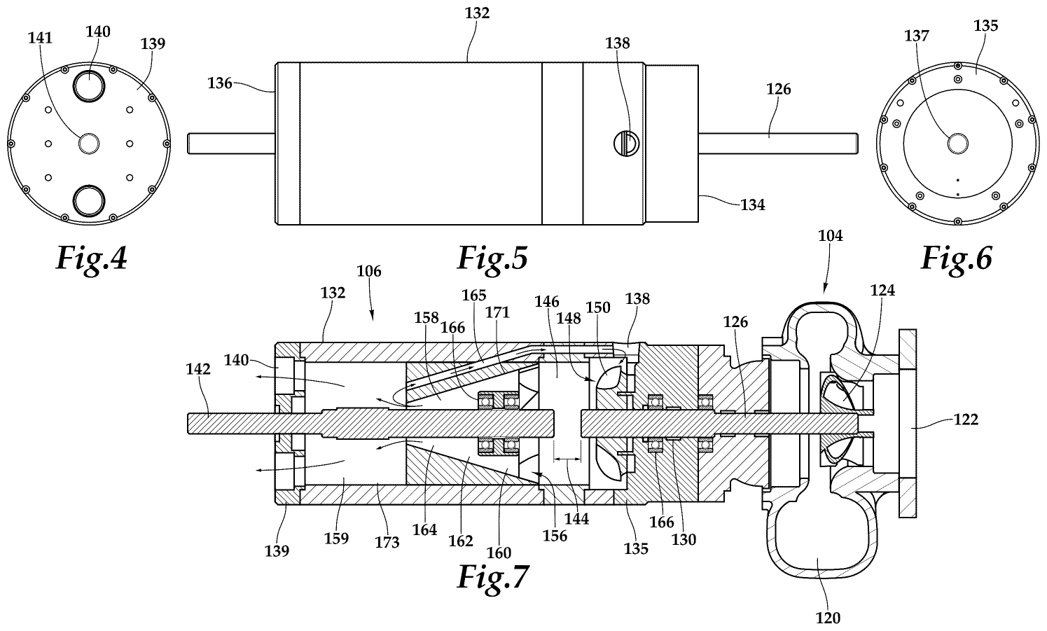

As shown in FIGS. 4-6, generator 106 may include a housing 132 having a front end 134 and a rear end 136. Front end 134 may include a front cap 135 configured to releasably couple front end 134 of housing 132. Front cap 135 may include an opening 137 configured to receive input shaft 126. Similarly, rear end 136 may include a rear cap 139 configured to releasably couple rear end 136 of housing 132. As shown, rear cap 139 may include one or more exhaust ports 140 and an opening 141 configured to receive output shaft 142 of generator 106, as detailed below. Although not shown, it is further contemplated that exhaust ports may extend radially from housing 132. While housing 132 is shown to be substantially circular, other shapes are contemplated, such as a conical shape.

Housing 132 may include one or more fluid inlets 138 configured to receive a fluid—such as a liquid, gas, and combinations of both. Preferably, inlet 138 receives a diesel fuel, though other fluids are contemplated, such as bio-diesel fuel, bio-fuel, alcohol, gasoline, gasohol, aviation fuel, and the like. In one embodiment, housing 132 includes two inlets and each inlet configured to be in an open position or a closed position to facilitate controlling the amount of fluid received by generator 106. It is further contemplated that each inlet may have the same diameter or varying diameters for regulating fluid flow.

Further, rear end 136 of housing 132 may output all or a portion of the exhaust and fluid via one or more outlets 140 of rear cap 139. Specifically, inlet 138 of generator 106 may be configured to receive air, fuel, and combinations of both for generating cavitation.

As shown in FIG. 7, generator 106 may be configured to receive input shaft 126 extending from exhaust turbine 104. Generator 106 may further include an output shaft 142. As shown, input shaft 126 and output shaft 142 may be aligned and separated a distance 144 from one another within an expansion combustion chamber 146. Distance 144 may range between about half an inch and about twelve. In certain embodiments, distance 144 may range between about one inch and about eight inches, and preferably about two inches. In particular, input shaft 126 and output shaft 142 may be separate components to facilitate applying variable speed and power to output device 108, such as a gear box or generator.

As shown in FIGS. 7-8, input shaft 126 may rotatably support a cavitation impeller 148 having a plurality of impeller blades 150. For example, impeller 148 may have anywhere between about five blades and about thirty blades. In one embodiment, impeller 148 includes eleven sigmoid or curved, proportionally spaced blades. Furthermore, as shown in FIG. 8, blades 150 of cavitation impeller 148 may extend from a rear surface 152 of an impeller frame 154, such that blades 150 are arranged to face rear end 136. Alternatively, blades of impeller 150 may extend from a front surface 155 of frame 154 to face front end 134. It is further contemplated that blades 150 of impeller 148 may extend from both front and rear surfaces 152, 155 such that cavitation impeller 148 is double-sided, i.e., blades 150 extend toward both front end 134 and rear end 136.

In operation, cavitation impeller 150 may be configured to receive rotational input from input shaft 126. For example, as auxiliary turbine wheel 124 is rotated in response to exhaust gases from engine 102, input shaft may drive cavitation impeller 148. As a fluid is fed into system 100, such as via inlet 138, the acceleration of cavitation impeller 148 to a high velocity may facilitate generating cavitation, thereby forming bubbles within the fluid. Cavitation impeller 148 also may be configured to create pressure and direct the flow of fluid and cavitation through expansion chamber 146.

Then, as each bubble passes into expansion chamber 146, an increase in pressure combined with the surface tension may result in a rapid collapse of the bubble diameter. Because of this rapid collapse, the contents of the bubble interior may combust to release heat energy for oxidative combustion and/or molecular decomposition. Particularly, unlike conventional systems that rely on a spark or igniter for combustion, the present disclosure is directed to a waste exhaust energy system 100 the facilitates cavitation implosion combustion.

The energy from the implosion of bubbles may be harnessed via output turbine 156 and transmitted to output shaft 142. The energy captured by output shaft 142 may facilitate transmitting power to output device 108 to, for example, drive a crankshaft or charge an external power source.

More specifically, when the local pressure of the fluid drops below its vapor pressure, bubbles in the fluid may expand as the internal bubble volume fills with fluid vapor. Moreover, as each bubble expands to a critical diameter and the pressure drop is suddenly released, such as when the fluid passes through combustion chamber 146, the pressure suddenly increases, and in combination with the surface tension forces on a surface of the bubbles, a rapid collapse of the bubble diameter may occur. When this collapse happens with sufficient intensity, the pre-collapse/collapse compression ratio can range from about 1000:1 to about 3000:1. This may facilitate producing a high temperature (e.g., several thousand Kelvin) inside the bubble, which may then ignite the bubble air fuel mixture and/or excite the bubble molecular bond particles decomposition.

As shown in FIGS. 2-7, output shaft 142 may extend from cavitation expansion chamber 146 through a vortex chamber 158 into a flow chamber 159 and exit housing 132 at rear end 136 via opening 141 of rear cap 139 or a radial exhaust port in shell 132. As illustrated in FIG. 7, vortex chamber 158 is shaped to resemble a venturi cone having, for example, a mouth portion 160, a throat portion 162, and a discharge portion 164. The shape of vortex chamber 158 may facilitate increasing the velocity and efficiency of fluid flow and cavitation micro-combustion through generator 106.

Moreover, as shown in FIG. 7, fluid and gases exiting chamber 158 at discharge portion 164 may be directed toward a recirculation path 165 of generator 106 to achieve internal recirculation. Recirculation path 165 may be in fluid communication with inlet 120. Moreover, recirculation path 165 may be configured to be in an open position or a closed position to facilitate controlling the amount of fluid recirculated back through inlet 120. For example, generator 106 may create a vacuum to draw fluid through recirculation path 165, which may be in an open position or a closed position to regulate the flow. In particular, because pressure at rear end 136 of generator 106 is higher (based on combustion and expansion) as compared to a pressure at front end 134, internal recirculation may naturally occur. In another example, fluid flow through recirculation path 165 may be electronically controlled by, for example, a solenoid or stepper motor for modulating a signal from a control unit.

Further, it is contemplated that expansion chamber 146 and/or vortex chamber 158 may facilitate producing vortex cavitation. Vortex cavitation may be initiated from the cavitation nuclei, which become longitudinal bubbles because of low pressure at the vortex core. The vortex, which may produce vortex cavitation, is a type of turbulent eddy. It is contemplated that the intensity of hydrodynamic cavitation in expansion chamber 146 and/or vortex chamber 158 may be enhanced by the vacuum generated at the core of the vortex. It is contemplated that the resulting cavitation may add to the efficiency and/or additional output power when the pressure is increased in the region where the bubble collapses without additional power.

As shown in FIG. 7-8, components of generator 106 within vortex chamber 158 may include a portion of output shaft 142 and output turbine 156. In particular, output turbine 156 may be mounted on output shaft 142 at mouth portion 160 of vortex chamber 158 for transmitting rotational energy, as detailed above. Moreover, as shown, a cantilevered bearing assembly or configuration 166 situated within vortex chamber 158 may be mounted on output shaft 142. In particular, the cantilevered bearing configuration 166 may include an aperture for receiving output shaft 142. Further bearing configuration 166 may include one or more spokes or arms 168 extending from a carrier 170 to an interior surface 171 of vortex chamber 158 for supporting output shaft 142 and reduce vibrations within system 100. Alternatively, spokes or arms 168 may extend from carrier 170 through vortex chamber 158 to an interior surface 173 of housing 132.

As shown in FIG. 8, output shaft 142 may be configured to support an output turbine 156 and output device 108. For instance, output shaft 142 may include one or more slits 143 for receiving and/or securing components of system 100. Other mechanical connections are contemplated.

Output turbine 156 may further include one or more blades 172. As shown, blades 172 may extend outwardly from a side of a turbine body 174. For instance, blades 172 may extend from body 174 toward interior surface 171 of vortex chamber 158. Further, blades 172 may be sigmoid, curved and/or tapered. For example, blades 172 may taper away from blades 150 of cavitation impeller 148. In another example, blades 172 may taper toward rear end 136 of housing 132. In yet another example, blades 172 may taper at an angle to conform to the conical shape of vortex chamber 158. In particular, a degree of tapering of blades 172 may range between about fifty degrees and about eighty degrees. In one embodiment, blades 172 may be tapered about seventy-three degrees. As detailed above, output turbine 156 may be configured to rotate output shaft 142 in response to fluid flow and cavitation micro-combustion. The rotational force may then be transferred to output device 108, such as an alternator or generator to facilitate creating useable energy from waste exhaust energy and pressure resulting from gases, fluids, cavitation, and combinations of each.

Comparing to conventional systems, use of cantilevered bearing configuration 166 in system 100 may improve the efficiency and overall output power. In one example, peak power prior to a cantilevered bearing configuration was 0.82 BHP at 4,499 input impeller RPM. Through use of vortex chamber 158 and cantilevered bearing configuration 166, 5.98 BHP has been measured. In another example, peak efficiency prior to cantilevered bearing implementation was about 10 to 12%. Through use of vortex chamber 158 and cantilevered bearing configuration 166, mechanical efficiencies of 70-95% have been measured, as detailed in the testing examples below.

### Exemplary Cavitation Impeller

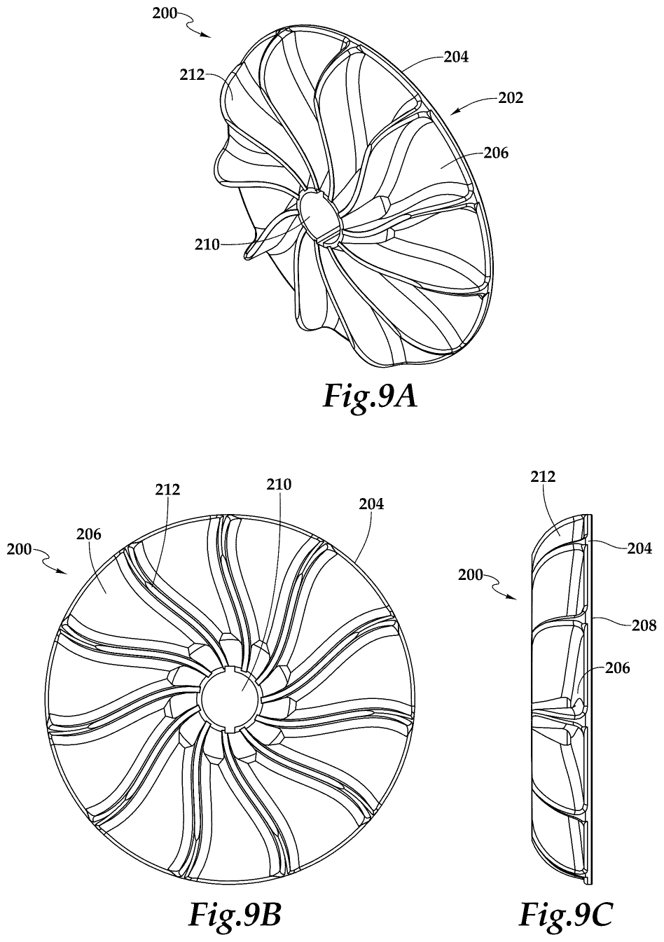

FIGS. 9A-9C illustrate an exemplary cavitation impeller 200, such as impeller 148 of system 100. As shown, impeller 200 has a body 202 defined by an edge 204. Body 202 may include a front surface 206 and a back surface 208, which may be substantially flat or planar.

A radius of body 202 may range between about two inches and about eight inches, and preferably between about three inches and about five inches. In certain embodiments, a radius of body 202 is about four and nine-tenths inches. While body 202 of impeller 200 is shown to be substantially circular, other shapes are contemplated.

Body 202 of impeller 200 may further include a central opening 210, which may include slits configured to receive lips or protrusions of an input shaft, such as input shaft 126 of system 100. Opening 210 may extend from front surface 206 to back surface 208. In particular, a radius of opening 210 may range between about a quarter of an inch and about one inches. In certain embodiments, a radius of opening 210 is about three quarters of an inch.

As shown in FIGS. 9A-9C, one or more blades 212 may extend outwardly from front surface 206 of body 202. Further, while blades 212 are shown to extend radially to 204, it is contemplated that blades 212 may extend radially past edge 204 as shown in FIG. 8. Impeller 200 may have anywhere between about five blades and about thirty blades. For testing purposes, impeller 200 was configured to have nine, eleven, thirteen or twenty-one blades.

Blades 212 may be designed to induce cavitation within a cavitation generator, such as generator 106 of system 100. The height of each blade 212 extending from front surface 206 may range between about half an inch and about three inches, and preferably between about one inch and about two inches. In certain embodiments, a height of each blade 212 extending from front surface 206 may be about one and two-thirds inches. As shown, blades 212 may be curved. Other shapes and styles of blades are contemplated, such as straight blades. Moreover, as mentioned above, it is contemplated that blades 212 extend from both front surface 206 and back surface 208 such that impeller 200 is double-sided.

### Exemplary Output Turbine Assembly

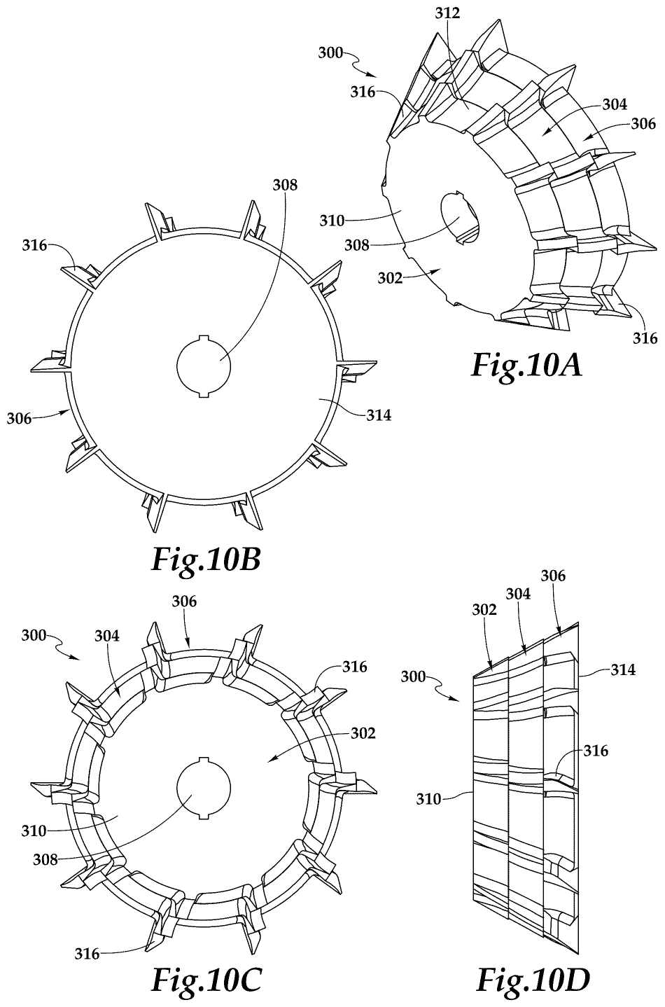

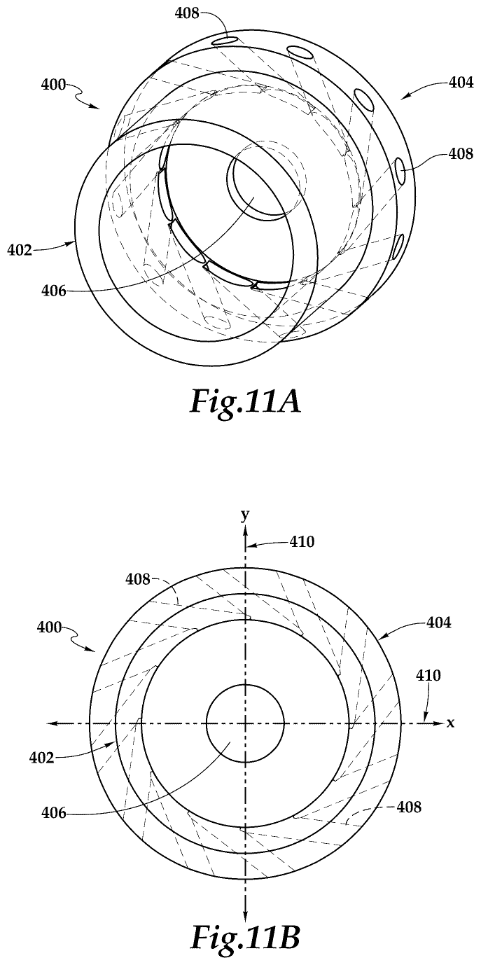

FIGS. 10A-10D illustrate an exemplary turbine assembly 300. As illustrated, turbine assembly 300 may include a first turbine 302, a second turbine 304, and a third turbine 306. Each turbine 302, 304, 306 may be similar in structure and operation to turbine 156 of system 100.

As shown, turbine assembly 300 may have a sigmoid, curved or tapered design such that a diameter of first turbine 302 may be smaller than a diameter of second turbine 304, which may have a smaller diameter compared to third turbine 306. It is contemplated that turbine assembly 300 may be incorporated into generator 106 and configured to conform to the shape of a chamber, such as the illustrated conical shape of vortex chamber 158.

A height of turbine assembly 300 may range between about three inches and about fifteen inches, and preferably between about five inches and about ten inches. A width of turbine assembly 300 may range between about one inch and about twenty inches, and preferably between about two inches and about ten inches.

As shown, each turbine 302, 304, 306 may be substantially circular and include a front surface 310, a side surface 312, and a rear surface 314. Font surface 310 and rear surface 314 may be substantially flat or planar.

Further, turbine assembly 300 may be structured such that each turbine 302, 304, 306 is aligned to define an opening 308. Opening 308 may include slits configured to receive lips or protrusions of an output shaft, such as output shaft 142 of system 100. A radius of opening 308 may range between about a quarter of an inch and about one inches. In certain embodiments, a radius of opening 314 is about three quarters of an inch.

As shown in FIGS. 10A-10D, side surface 312 of each turbine 302, 304, 306 may include one or more blades 316 extending from side surface 312. A height of blades 316 from side surface 312 may range between about a quarter of an inch and about five inches, and preferably between about half an inch and about three inches. Further, blades 316 of turbine assembly 300 may be structured to reduce any dead volume by, for example, progressively decreasing in height between each turbine 302, 304, 306. For instance, blades 316 of first turbine 302 may extend out about half an inch, blades 316 of second turbine 304 may extend out about six tenths of an inch, and blades 316 of third turbine 306 may extend out about one inch. As shown in FIG. 10D, based on this configuration, when aligned, the blades 316 of each turbine 302, 304, 306 may appear to form a single or uniform curved and/or tapered blade.

### Exemplary Jet Turbine

FIGS. 11A-11B illustrate an exemplary jet turbine 400. Although not shown in FIGS. 1-7, it is contemplated that jet turbine 400 may be incorporated into generator 106 of system 100. For example, jet turbine 400 may be positioned in flow chamber 159 and rotatably mounted on output shaft 142 to, for example, capture energy based on gases and fluids released from vortex chamber 158. The energy transmitted through output turbine 400 may then be harvested and used to accelerate the speed of output shaft 142 for transfer of additional power to output device 108.

Top member 402 may be substantially cylindrical. A height of top member 402 may range between about two inch and about five inches, and preferably between about three inches and about four inches. A diameter of top member 402 may range between about two inches and about eight inches, and preferably between about four inches and about six inches. In certain embodiments, top member 402 may have a diameter of about five inches.

Bottom member 404 may be substantially circular and configured to have a diameter that is larger than the diameter of top member 402. More specifically, a diameter of bottom member 404 may range between about three inches and about nine inches, and preferably between about five inches and about seven inches. In certain embodiments, bottom member 404 may have a diameter of about six inches. Further, a height of bottom member 404 may range between about half an inch and about two inches, and preferably between about three quarters of an inch and about an inch and a quarter. In certain embodiments, bottom member 404 may have a height of about one inch.

As shown in FIG. 9A and FIG. 9B, bottom member 404 may include an opening 406 configured to receive, for example, an output shaft such as output shaft 142 of system 100. Further, bottom member 404 may include a plurality of exit ports 408. A diameter of exit ports 408 may range between about a quarter of an inch and about three quarters of an inch, and preferably be about half of an inch.

Exits ports 408 may be angled in relation a plane 410 of bottom member 404 to, for example, facilitate rotation of jet turbine 400. For instance, an angle of exits ports 408 in relation to an x-axis of plane 410 may range between about twenty degrees and about fifty degrees, and preferably between about thirty degrees and about forty degrees. Further, an angle of exit ports 408 in relation to a y-axis of plane 410 may range between about one hundred and twenty degrees and about one hundred and sixty degrees, and preferably between about one hundred and thirty degrees and about one hundred and fifty degrees. In operation, exit ports 408 spray out an energized fluid that cause jet turbine 400 rotate at a high RPM. Fluid that dispenses through ports 408 may be conveyed to, for example, a fluid reservoir that can reintroduce the collected fluid into a system, such as a system.

As detailed above, jet turbine 400 may be configured to capture energy released from the implosion of bubbles. The energy transmitted through jet turbine 400 may then be harvested and transferred to, for example, an output shaft that could be coupled to a crankshaft or an alternator/generator creating useable energy from waste exhaust energy and pressure.

As discussed above, outlet turbine 400 may be configured to capture energy released from, for example, fluid flow and cavitation combustion. The energy transmitted through output turbine 400 may then be harvested and transferred to, for example, an output shaft that could be coupled to a crankshaft or an alternator/generator creating useable energy from waste exhaust energy and pressure.

### Exemplary Retrofit Kit

A kit may be provided for retrofitting certain above disclosed features to other waste exhaust energy recovery systems. These systems may lack an exhaust turbine, a vortex drive and cavitation generator, an output device, or other features disclosed herein. For example, the kit may include an exhaust turbine including a turbine wheel for connecting to an existing internal combustion engine.

The kit may also include a generator, such as generator 106 of FIGS. 1-7, configured to generate cavitation, harness the implosion of bubbles, and transmit energy to an output shaft. More specifically, a retrofit generator may include a cavitation impeller supported on an input shaft for generating cavitation that is used to drive an output turbine mounted on an output shaft. Input shaft and output shaft may further support a cantilever bearing configuration to increase velocity and efficiency of fluid flow and cavitation micro-combustion. The shafts of a retrofit kit may be separated to facilitate applying variable speed and power. Further, the generator may further include one or more chambers, such as a combustion chamber, a vortex (venturi) chamber, and a flow chamber.

The kit may also include output device, such as output device 108 of FIG. 1. Output device may be a generator configured to generate an electrical current for powering or recharging a power source (e.g., battery) or may include a plurality of gears mechanically coupled to, for example, a crankshaft or other device to increase a vehicle torque, horsepower, efficiency, and the like.

Furthermore, the described system 100 above and/or a retrofit kit may further include a number of sensors and actuators that facilitate various functions. Examples of sensors may include RPM sensors, pressure sensors, temperature sensors, and mass air flow sensors. Examples of actuators may include wastegate valve actuators, metering actuators, relief valves, pressure valves, bleed valves, bypass loops, de-aeration loop metering valves, and air inlet.

System 100 and/or retrofit kit may further include a central control unit or processor. The processor may be a general-purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, any conventional processor, controller, microcontroller, or state machine. A general-purpose processor may be considered a special purpose processor while the general-purpose processor is configured to execute instructions (e.g., software code) stored on a computer readable medium. A processor may also be implemented as a combination of computing devices, such as a combination of a DSP and a microprocessor, a plurality of microprocessors, one or more microprocessors in conjunction with a DSP core, or any other such configuration.

A processor of system 100 may be configured to receive inputs and issue output signals. The output signals produced by processor may be to a component of the system. In certain embodiments, the processor may be configured to send one or more control signals to an actuator based on input signals received from sensors to, for example, control air/fuel ratio, cavitation rate, heat release, impeller input speed etc.

### Testing

A full load speed sweep test was performed with varying amounts of recirculation and exhaust restriction using an eight-inch waste energy recovery system. An increase of input BHP in the impeller resulted in the following mechanical efficiency:

| Input BHP | Efficiency |
|---|---|
| 1 | ~80% |
| 2.5 | ~68% |
| 6 | ~56% |
| 7.5 | ~51% |

The power recorded is based on a calibrated dyno curve. Actual torque was measured as a function of speed and all data is normalized using input power.

In comparing to systems of varying diameters, an eight-inch system achieved an estimated 900% increase in BHP output over a fifteen-inch system with 650% better efficiency. This significant increase is mainly a result of the cantilevered bearing configuration described herein, which is not implemented in known systems.

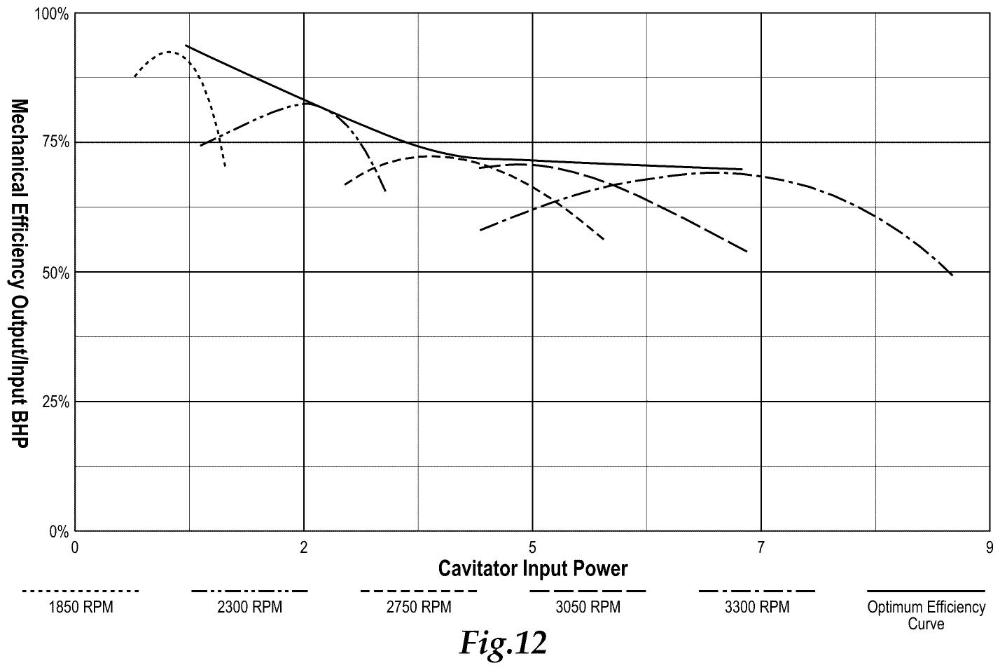

Further, as illustrated in the graph of FIG. 12, a speed sweep test was performed to compare varying input brake horsepower (BHP) and measuring the mechanical efficiency. Generally, the mechanical efficiency peaked at 50% power at any given speed:

| Input BHP | Efficiency |
|---|---|
| 1 | ~94% |
| 2.5 | ~82% |
| 6 | ~72% |
| 7.5 | ~71% |

Another test was performed to measure maximum output power. Applied input powers at increasing speeds resulted in the following output powers:

| Input BHP | Output power |
|---|---|
| 1.5 | 1 |
| 3 | 2 |
| 4.75 | 3.1 |
| 6.3 | 4.1 |
| 8.5 | 5.1 |

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described in the application are to be taken as examples of embodiments. Components may be substituted for those illustrated and described in the application, parts and processes may be reversed, and certain features of the invention may be utilized independently, all as would be apparent to one skilled in the art after having the benefit of this description of the invention. Changes may be made in the elements described in the application without departing from the spirit and scope of the invention as described in the following claims.

1. A waste exhaust energy recovery system comprising:
an exhaust turbine including a turbine wheel mounted on an input shaft;
a generator coupled to said exhaust turbine, said generator configured to receive said input shaft and further including an inlet configured to receive a fluid;
a cavitation impeller mounted on said input shaft within said generator, said cavitation impeller configured to induce cavitation within the fluid;
an output shaft extending into a vortex chamber of said generator;
an output turbine mounted on said output shaft, said output turbine, in response to cavitation implosion combustion, configured to rotate and drive said output shaft; and
a cantilever bearing assembly configured to support said output shaft, wherein said cantilever bearing assembly facilitates reducing vibration with said generator.

2. The system of claim 1, wherein said exhaust turbine is configured to receive exhaust energy from an internal combustion engine to facilitate rotating said turbine wheel.

3. The system of claim 1, further comprising an output device configured to receive a rotational input from said output shaft.

4. The system of claim 3, wherein said output device is configured to generate electricity or a mechanical force.

5. The system of claim 1, wherein said input shaft is spaced a distance from said output shaft to optimize the cavitation implosion combustion, the cavitation implosion combustion configured to facilitate accelerating a speed of said output turbine.

6. The system of claim 1, wherein cavitation impeller includes a plurality of impeller blades extending from a surface of an impeller frame.

7. The system of claim 6, wherein said plurality of impeller blades are curved and proportionally spaced about said surface of said impeller frame.

8. The system of claim 6, wherein said plurality of impeller blades extend from a front surface and a rear surface of said impeller frame.

9. The system of claim 1, wherein said vortex chamber is shaped to resemble a venturi cone having a mouth portion, a throat portion, and a discharge portion, said vortex chamber configured to facilitate increasing the velocity of the fluid flow through said generator.

10. The system of claim 1, wherein said output turbine includes a plurality of blades extending outwardly toward an interior surface of said vortex chamber.

11. The system of claim 10, wherein said blades of said output turbine are tapered to conform to a conical shape of said vortex chamber.

12. The system of claim 1, wherein said cantilever bearing configuration is positioned proximate to said output turbine, said bearing configuration including one or more arms extending from a carrier.

13. The system of claim 1, wherein said arms extend from said carrier to an interior surface of said vortex chamber.

14. The system of claim 1, wherein said generator further including a recirculation path in fluid communication with said inlet, said recirculation path configured to facilitate internal recirculation of the fluid.

15. The system of claim 14, wherein said recirculation path may be configured to be in an open position or a closed position to facilitate controlling an amount of the fluid recirculated back through said inlet.

16. A retrofit kit for a waste exhaust energy recovery system for generating cavitation, the kit comprising:
a generator including a housing having a plurality of chambers;
a front end of said housing configured to receive an input shaft, said input shaft configured to receive a rotational input from a turbine wheel driven by exhaust energy;
a cavitation impeller mounted on said input shaft for generating cavitation within a fluid received via an inlet of said housing;
an output shaft extending through said housing and exiting said rear end, said output shaft configured to couple with an output device outside said housing;
an output turbine mounted on said output shaft, said output turbine configured to rotate in response to combustion of the cavitation and fluid flow; and
a cantilever bearing assembly configured to support said output shaft, wherein said cantilever bearing assembly includes one or more arms extending from a carrier to a surface of said housing to support the carrier of cantilever bearing assembly.

17. The retrofit kit of claim 16, wherein said input shaft is spaced a distance from said output shaft to optimize cavitation combustion for accelerating said cavitation impeller.

18. The retrofit kit of claim 16, wherein said plurality of chambers includes an expansion combustion chamber to facilitate cavitation combustion and a vortex chamber to facilitate increasing the velocity of fluid flow through said housing.

19. The retrofit kit of claim 18, wherein said vortex chamber is configured to generate vortex cavitation, wherein the vortex chamber is shaped to resemble a venturi cone having a mouth portion, a throat portion, and a discharge portion, and the fluid exiting the discharge portion is directed to a recirculation path in fluid communication with said inlet to facilitate internal recirculation of the fluid.

20. The retrofit kit of claim 16, wherein said output device is at least one of a current generator configured energize a power source, a gear assembly configured to generate a mechanical energy, and a cog belt and gears.
